(19) United States
(12) Patent Application Publication
(10) Pub. No.: US 2019/0045212 A1
(43) Pub. Date: Feb. 7, 2019

(54) METHOD AND APPARATUS FOR PREDICTIVE CODING OF 360º VIDEO

(71) Applicant: The Regents of the University of California, Oakland, CA (US)

(72) Inventors: Kenneth Rose, Ojai, CA (US); Tejaswi Nanjundaswamy, Goleta, CA (US); Bharath Vishwanath, Santa Barbara, CA (US)

(21) Appl. No.: 16/056,089

(22) Filed: Aug. 6, 2018

Related U.S. Application Data
(60) Provisional application No. 62/542,003, filed on Aug. 7, 2017.

(51) Int. Cl. H04N 19/52; H04N 5/232; H04N 19/105; H04N 19/59; H04N 19/172

(52) U.S. Cl. CPC H04N 19/52; H04N 5/23238; H04N 19/172; H04N 19/59; H04N 19/105

(57) ABSTRACT

A method and apparatus for predictive coding of spherical or 360-degree video. To achieve efficient compression, a rotational motion model is introduced to characterize motion on the sphere, specifically, in terms of sphere rotations about given axes. This model preserves an object's shape and size on the sphere. A motion vector in this model implicitly specifies an axis of rotation and the degree of rotation about that axis, to convey actual motion of the object on the sphere. Complementary to the rotational motion model, an effective location-invariant motion search technique that is agnostic of the projection format is provided that is tailored to the sphere's geometry. Experimental results demonstrate that the preferred embodiments of this invention achieve significant gains over prevalent motion models, across various projection geometries.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 62/542,003, filed on Aug. 7, 2017, by Kenneth Rose, Tejaswi Nanjundaswamy, and Bharath Vishwanath, entitled “Method and Apparatus for Predictive Coding of 360° Video,” attorneys' docket number 30794.658-US-P1.

### BACKGROUND OF THE INVENTION

### 1. Field of the Invention

This invention relates to a method and apparatus for predictive coding of 360° video.

### 2. Description of the Related Art

(Note: This application references a number of different publications as indicated throughout the specification by one or more reference numbers within brackets, e.g., [x]. A list of these different publications ordered according to these reference numbers can be found below in the section entitled “References.” Each of these publications is incorporated by reference herein.)

Virtual reality and augmented reality are transforming the multimedia industry with major impacts in the field of social media, gaming, business, health and education. The rapid growth of this field has dramatically increased the prevalence of spherical video. High-tech industries with applications and products involving spherical video include consumer oriented content providers such as large-scale multimedia distributors Google™/YouTube™ and Facebook™; 360° video based game developers such as Microsoft™ and Facebook™; and other broadcast providers such as ESPN™ and BBC™. The spherical video signal, or 360° (360-degree) video signal, is video captured on a sphere that encloses the viewer, by omnidirectional or multiple cameras. It is a key component of immersive and virtual reality applications, where the end user can control in real time the viewing direction.

With increased field of view, 360° video requires higher resolution videos compared to standard 2D videos. Given the enormous amount of data consumed by spherical video, the practicality of applications using such video critically depends on powerful compression algorithms that are tailored to this signal characteristics. In the absence of codecs that are tailored to spherical video, prevalent approaches simply project the spherical video onto a plane or set of planes via a 2D projection format such as the Equirectangular Projection or the Cubemap Projection [1], and then use standard video codecs to compress the projected video. The key observation is that a uniform sampling in the projected domain induces a varying sampling density on the sphere, which further varies across different projection formats. A brief review of two popular projection formats is provided next:

Equirectangular Projection (ERP): This format is obtained by considering the latitude and longitude of a point on the sphere to be 2D Cartesian coordinates on a plane. The sampling pattern for ERP and the corresponding 2D projection are shown in FIGS. 1(a)-1(b). FIG. 1(a) illustrates the sphere sampling pattern for equirectangular projection, wherein X, Y and Z are the Cartesian coordinates of the 3 dimensional space, θ is the polar angle, φ is the azimuthal angle, A0-A6 enumerate latitudes (corresponding to distinct polar angles), L0-L6 enumerate longitudes (corresponding to distinct azimuthal angles) and p is the point of intersection of latitude A1 and longitude L4. FIG. 1(b) illustrates the corresponding 2D projection, wherein u and v denote the coordinates. Clearly, objects near the pole get stretched dramatically in this format.

Cubemap Projection (CMP): This format is obtained by radially projecting points on the sphere to the six faces of a cube enclosing the sphere, as illustrated in FIG. 2, wherein X, Y and Z are the Cartesian coordinates of the 3 dimensional space and p is an example point. The six faces are then unfolded. Warping is reduced in this format when compared to ERP, but it is still significant near the corners of the faces.

The Joint Video Exploration Team (WET) document [10] provides a more detailed discussion of these formats including procedures to map back and forth from a sphere to these formats.

A central component in modern video codecs such as H.264 [2] and HEVC [3] is motion compensated prediction, often referred to as “inter-prediction”, which is tasked with exploiting temporal redundancies. Standard video codecs use a (piecewise) translational motion model for inter prediction, while some nonstandard approaches considered extensions to affine motion models that may be able to handle more complex motion, at a potentially significant cost in side information (see recent approaches in [4, 5]). Still, in 360° video, the amount of warping induced by the projection varies for different regions of the sphere, and yields complex non-linear motion in the projected plane, for which both the translation motion model and its affine motion extension are ineffective. Note that even a simple translation of an object on the unit sphere leads to complex nonlinear motion in the projected domain. Moreover, motion vector in the projected domain doesn't have any meaningful physical interpretation. Thus, a new motion compensated prediction technique that is tailored to the setting of 360° video signals is needed.

At the encoder, motion estimation is performed to determine the best motion vector among the set of motion vector candidates. Standard video coding techniques define a fixed motion search pattern and motion search range in the projected domain. With the varying sampling density on the sphere for a given projection format, the fixed search pattern defined in the projected domain induces widely varying search patterns and search ranges depending on location on the sphere. This causes considerable suboptimality of the motion estimation stage.

Few approaches try to address the challenges in motion compensation for spherical video, which include:

Translation in 3D space: Li et al., proposed 3D translational motion model for the cubemap projection [8]. In this approach, the centers of the current coding block and the reference block are mapped to the sphere and the 3D displacement between these vectors is calculated. The remaining pixels in the current coding block are also mapped to the sphere and then translated by the same displacement vector obtained for the block center. However, these translated vectors are not guaranteed to be on the sphere and thus need to be projected to it. Due to this final projection, object shape and size are not preserved, and some distortion is introduced. Moreover, motion search in this approach depends on the projection geometry, and thus the search range, pattern and precision vary across the sphere, depending on the sampling density.

Tosic et al., propose in [9] a multi-resolution motion estimation algorithm to match omnidirectional images, while operating on the sphere. However, their motion model is largely equivalent to operating in the equirectangular projected domain, and results in suboptimalities associated with this projection.

A closely related problem is that of motion-compensated prediction in video captured with fish-eye cameras, where projection to a plane also leads to significant warping. A few interesting approaches have been proposed to address this problem in [6, 7], but these do not apply to motion under different projection geometries for 360° videos.

Thus, the critical shortcomings of the motion model in the standard approach and other proposed approaches, coupled with the suboptimalities of the motion search patterns employed for motion estimation in 360 video coding, strongly motivate this invention whose objective is to achieve new and effective motion model and motion search pattern, tailored to the critical needs of spherical video coding.

### SUMMARY OF THE INVENTION

The present invention provides an effective solution for motion estimation and compensation in spherical video coding. The primary challenge, due to performing motion compensated prediction in the projected domain, is met by introducing a rotational motion model designed to capture motion on the sphere, specifically, in terms of sphere rotations about given axes. Since rotations are unitary transformations, the present invention preserves the shape and area of the objects on the sphere. A motion vector in this model implicitly specifies an axis of rotation and the degree of rotation about that axis. This model also ensures that for a given motion vector, a block is rotated by the same extent regardless of its location on the sphere. This feature overcomes the main motion search suboptimalities of current approaches, by allowing the search pattern, range and precision to be independent of the position of the block on the sphere. Complementary to the motion model, the invention provides a new pattern of “radial” search around the center of the coding block on the sphere for further performance improvement. Performing motion compensation on the sphere and having a fixed motion search pattern renders the method agnostic of the projection geometry, and hence universally applicable to all current projection geometries, as well as any that may be discovered in the future. Experimental results demonstrate that the preferred embodiments of the invention achieve significant gains over prevalent motion models, across various projection geometries.

In one aspect, the present invention provides an apparatus and method for processing a multimedia data stream, comprising: a codec for processing a multimedia data stream comprised of a plurality of frames, wherein the codec comprises an encoder, a decoder, or both an encoder and a decoder; the encoder processes the multimedia data stream to generate encoded data and the decoder processes the encoded data to reconstruct the multimedia data stream; the multimedia data stream contains a spherical video signal; and the encoder or the decoder comprises a motion-compensated predictor, which predicts a portion of a current frame from a corresponding portion of one or more reference frames, after motion compensation, and the motion compensation is comprised of rotation on a sphere about an axis.

The encoded data comprises motion information for a portion of the current frame, which identifies the axis and a degree of rotation about the axis.

The motion-compensated predictor further performs interpolation in the reference frames to enable the motion compensation at a sub-pixel resolution.

The encoder further performs a motion search on a radial grid comprised of a plurality of grid points that lie on two or more geodesics that intersect at a center of the portion of the current frame.

In another aspect, the present invention provides an apparatus and method for processing a multimedia data stream, comprising: a codec for processing a multimedia data stream comprised of a plurality of frames, wherein the codec comprises an encoder, a decoder, or both an encoder and a decoder; the encoder processes the multimedia data stream to generate encoded data and the decoder processes the encoded data to reconstruct the multimedia data stream; the multimedia data stream contains a spherical video signal; and the encoder comprises a motion-compensated predictor, which predicts a portion of a current frame from a corresponding portion of one or more reference frames, and the encoder further performs a motion search on a radial grid comprised of a plurality of grid points that lie on two or more geodesics that intersect at a center of the portion of the current frame.

An orientation of the two or more geodesics that intersect at the center of the portion of the current frame is such that the two or more geodesics are separated by equal angular displacements, and the grid points are equally spaced along the two or more geodesics.

### BRIEF DESCRIPTION OF THE DRAWINGS

Referring now to the drawings in which like reference numbers represent corresponding parts throughout:

FIG. 1(a) illustrates a sphere sampling pattern for equirectangular projection (ERP) and FIG. 1(b) illustrates a corresponding 2D projection.

FIG. 2 illustrates a cubemap projection (CMP) for a sphere.

FIGS. 3(a), 3(b), 3(c) and 3(d) illustrate various steps in an embodiment of this invention for motion compensation, wherein FIG. 3(a) depicts a block in a current ERP frame; FIG. 3(b) depicts the block after mapping to a sphere; FIG. 3(c) depicts rotation of the block on the sphere; and FIG. 3(d) depicts the rotated block after mapping back to the ERP domain.

FIG. 4(a) depicts a high-efficiency video coding (HEVC) search pattern and FIG. 4(b) illustrates an embodiment of this invention for a radial search pattern.

FIGS. 5(a), 5(b) and 5(c) illustrate the effect of different motion models on the block shape, wherein FIG. 5(a) shows the outcome of the HEVC motion model; FIG. 5(b) the outcome of the three-dimensional (3D) translation motion model; and FIG. 5(c) is the outcome of an embodiment of this invention for rotational motion model.

FIG. 6 is a schematic diagram illustrating an exemplary embodiment of a multimedia coding/decoding (codec) system that can be used for transmission/reception or storage/retrieval of a multimedia data stream according to one embodiment of the present invention.

FIG. 7 is an exemplary hardware and software environment used to implement one or more embodiments of the invention.

FIG. 8 illustrates the logical flow for processing a multimedia signal in accordance with one or more embodiments of the invention.

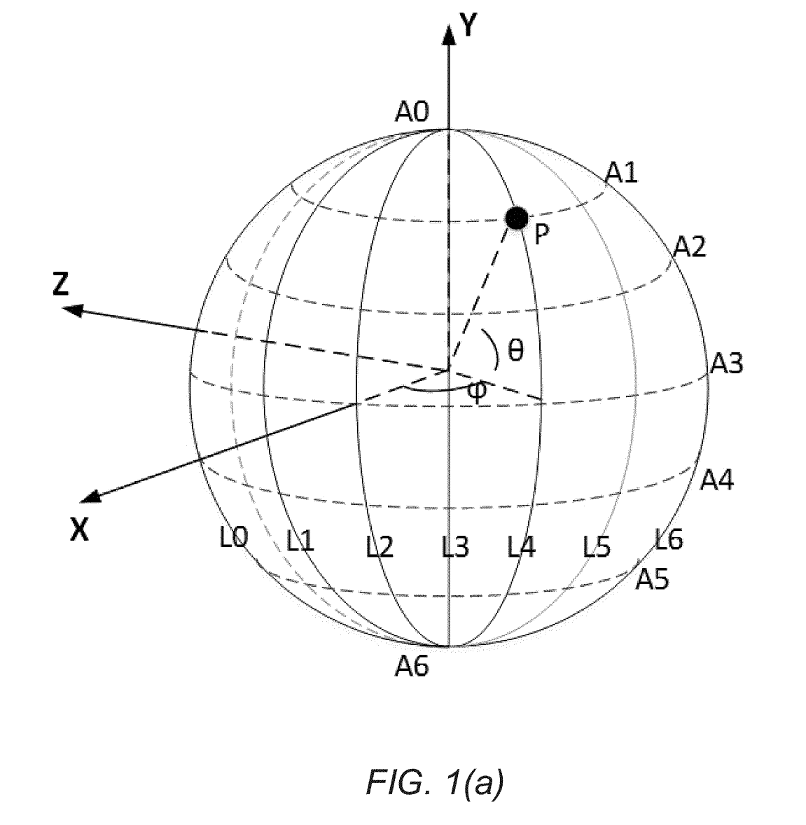

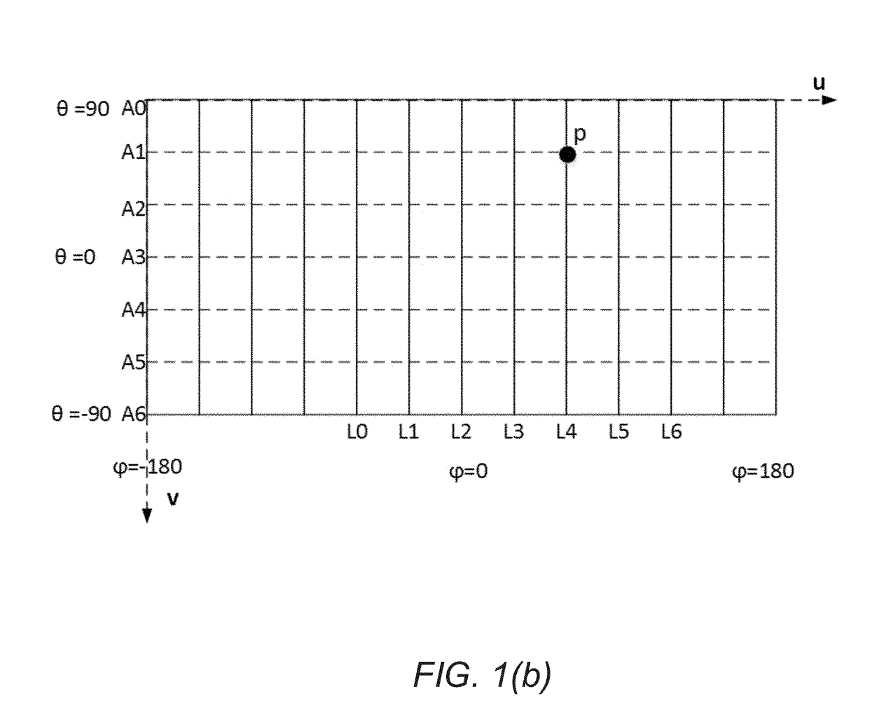

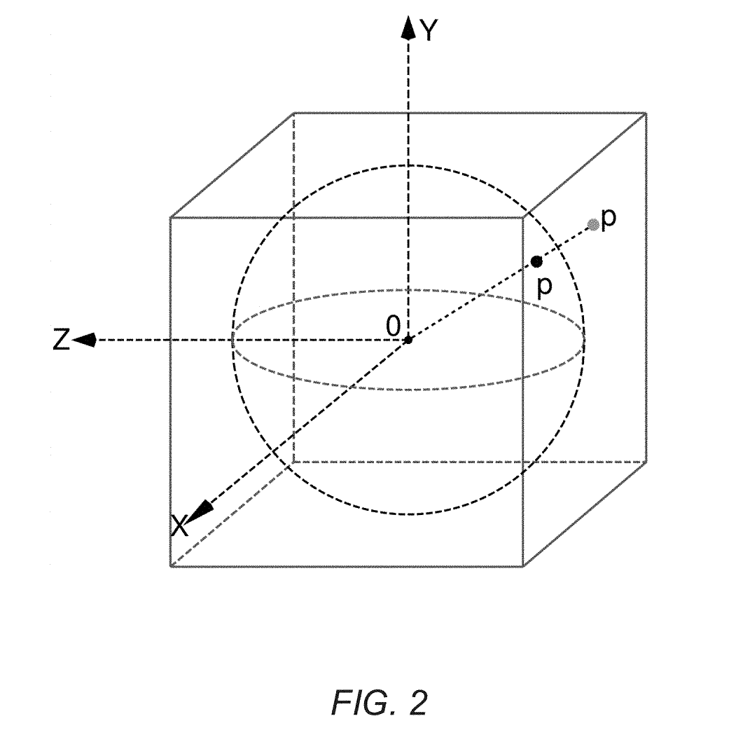

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Overview

The efficient compression of spherical video is pivotal for the practicality of many virtual reality and augmented reality related applications. Since 360° video represents the scene captured on the unit sphere, this invention characterizes motion on the sphere in its most natural way. The invention provides a rotational model to characterize angular motion on the sphere. In the invention, motion is defined as rotation of a portion of a frame, typically a block of pixels, on the surface of the sphere about a given axis, and information specifying this rotation as “motion vector” is transmitted in lieu of the block displacement in the 2D projected geometry. Complementary to the motion model, the invention provides a location invariant motion “radial” search pattern. The method in the invention is thus agnostic of the projection geometry and can be easily extended to other projection formats.

Such embodiments have been evaluated after incorporation within existing coding frameworks, such as within the framework of HEVC. Experimental results for these embodiments provide evidence for considerable gains, and hence for the effectiveness of such embodiments.

Technical Description

1. Prediction Framework with a Rotational Motion Model

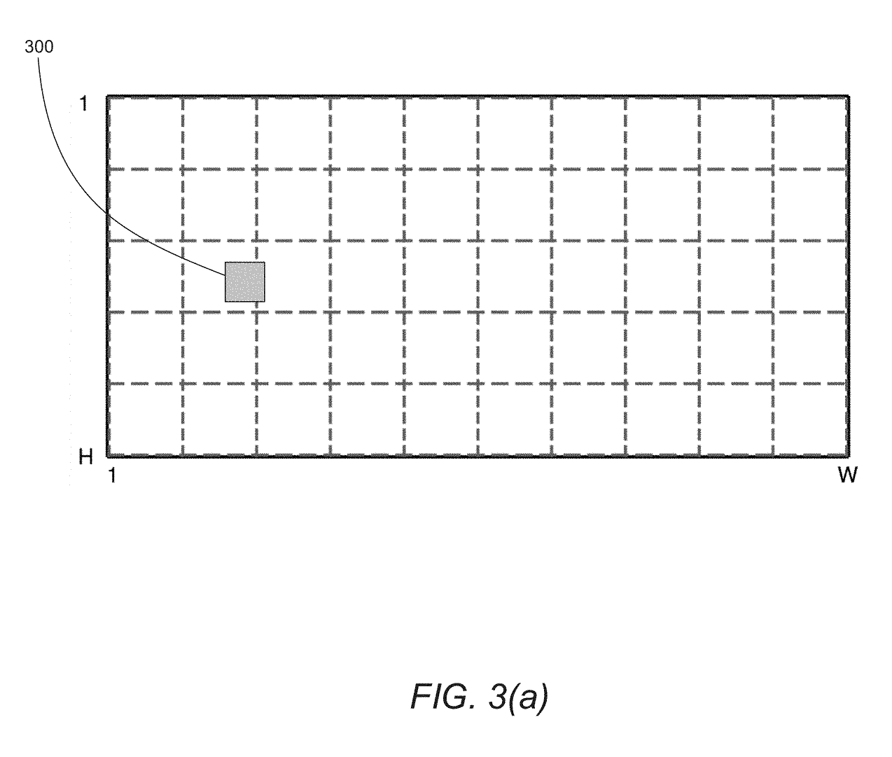

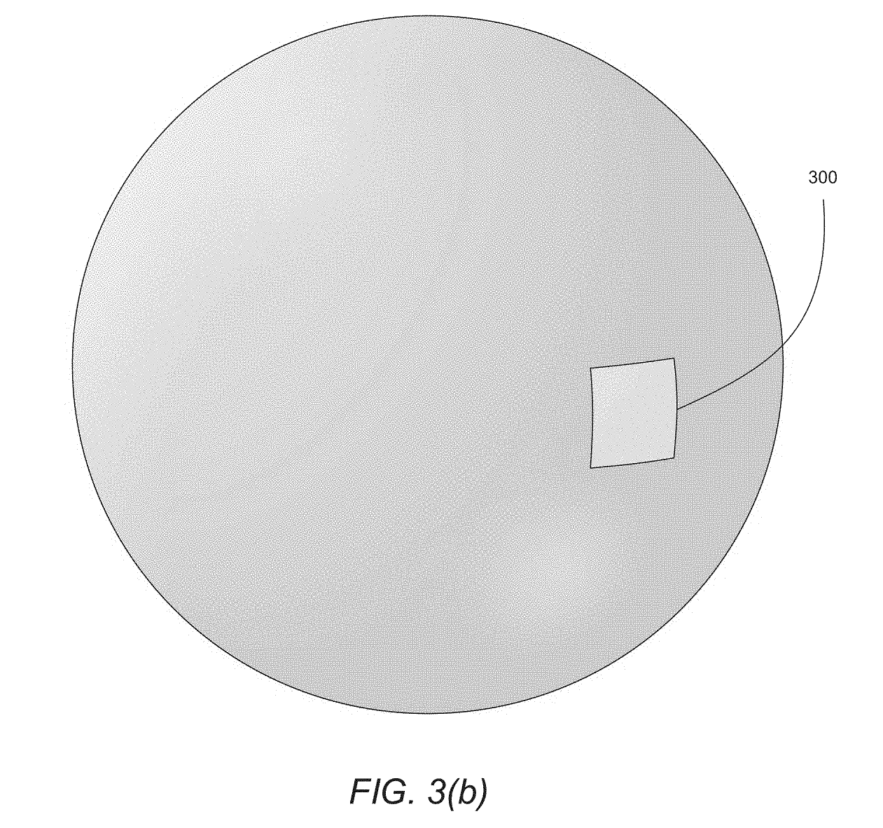

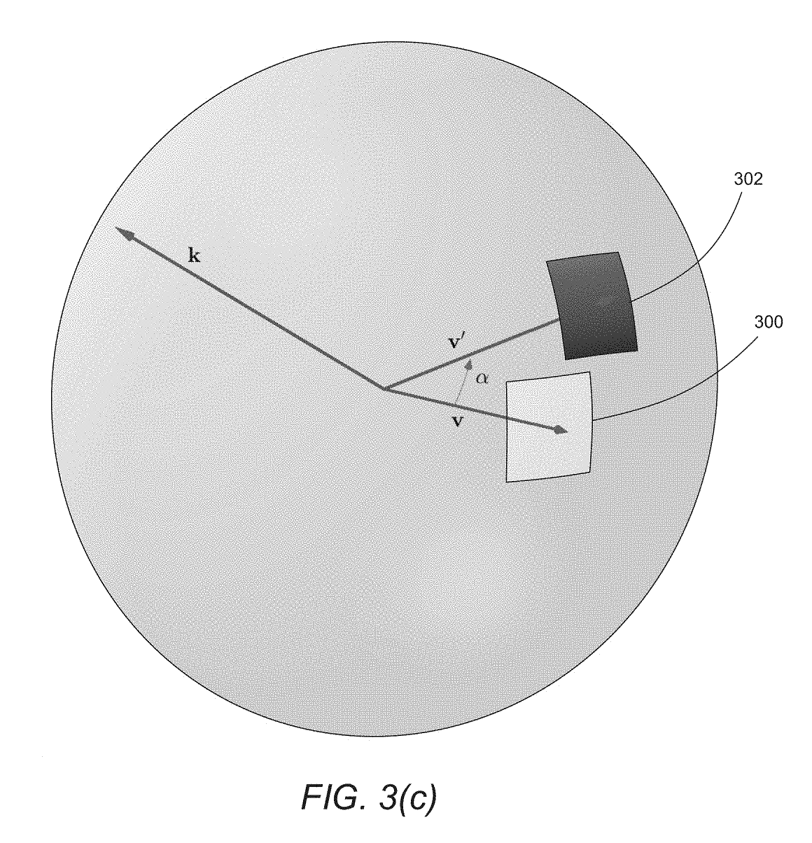

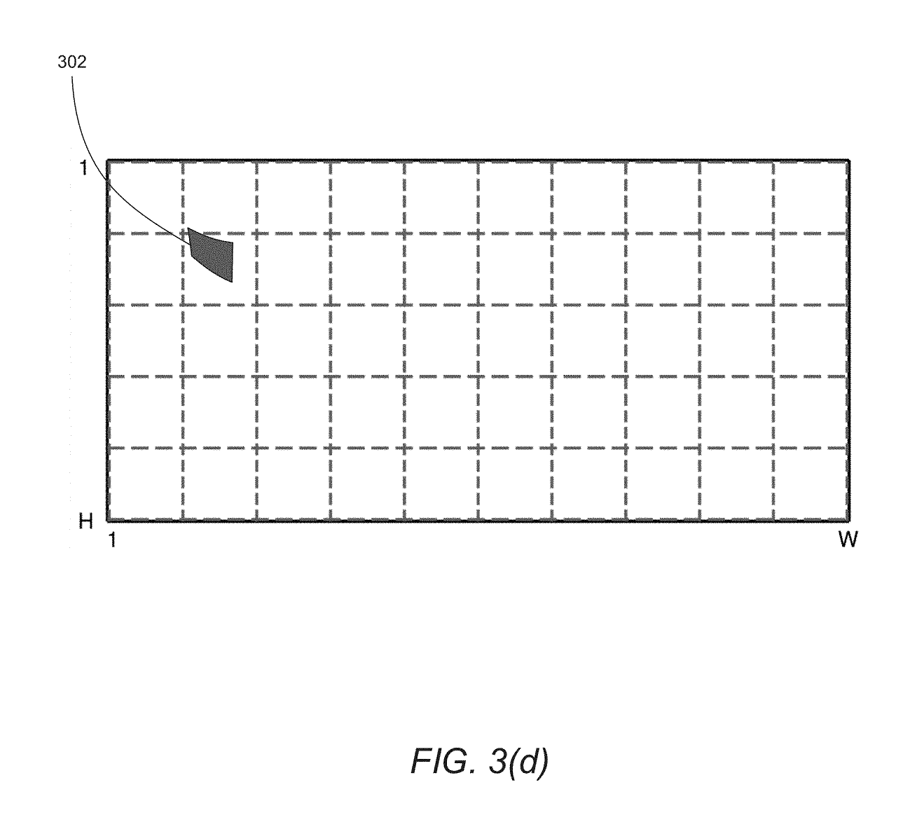

Since motion compensated prediction in the projected domain lacks a precise physical meaning, the following embodiments provide a method to perform motion compensation directly on the sphere. The overall paradigm for the motion compensated prediction is illustrated in FIGS. 3(a)-3(d), wherein FIG. 3(a) shows a block 300 in a current ERP frame with height H and width W; FIG. 3(b) depicts the block 300 after mapping to a sphere; FIG. 3(c) depicts spherical rotation of the block 300, whose center is denoted by vector v, about an axis given by vector k and by an angle α, to obtain rotated block 302, whose center is denoted by vector v′; and FIG. 3(d) shows rotated block 302 after mapping back to the ERP domain.

Consider a portion of the current frame, typically a block of pixels, in the projected domain, which is to be predicted from the reference frame. As noted above, an example of such a block 300 in the ERP domain is illustrated in FIG. 3(a). The block 300 of pixels in the current frame is mapped to the sphere using the inverse projection mapping. The example block 300 in FIG. 3(a) after mapping to the sphere is illustrated in FIG. 3(b). Let the center of this coding block in the projected domain correspond after mapping to vector v on the sphere. The motion search grid around the vector v is described next.

2. Location Invariant Radial Search Pattern

The following embodiment focuses on a location invariant search pattern that eliminates a significant suboptimality of motion search patterns in standard techniques. As previously mentioned, one of the main shortcomings of performing motion search in the projected domain is that the corresponding (on the sphere) search range, pattern and precision vary with location across the sphere. Since in the preferred embodiment of this invention, motion-compensated prediction is performed by spherical rotations and not on the projected plane, such arbitrary variations can be avoided, and the same search pattern is employed for blocks everywhere on the sphere, agnostic of the projection geometry.

Let {(m, n)} be the set of integer motion vectors and let R be the predefined search range, i.e., −R≤{m, n}≤R. To illustrate the search grid, pretend for a moment that v is the north pole. Then, the motion vector (m, n) defines the rotation of v to a new point v′ whose spherical coordinates (φ′, θ′) are given by:

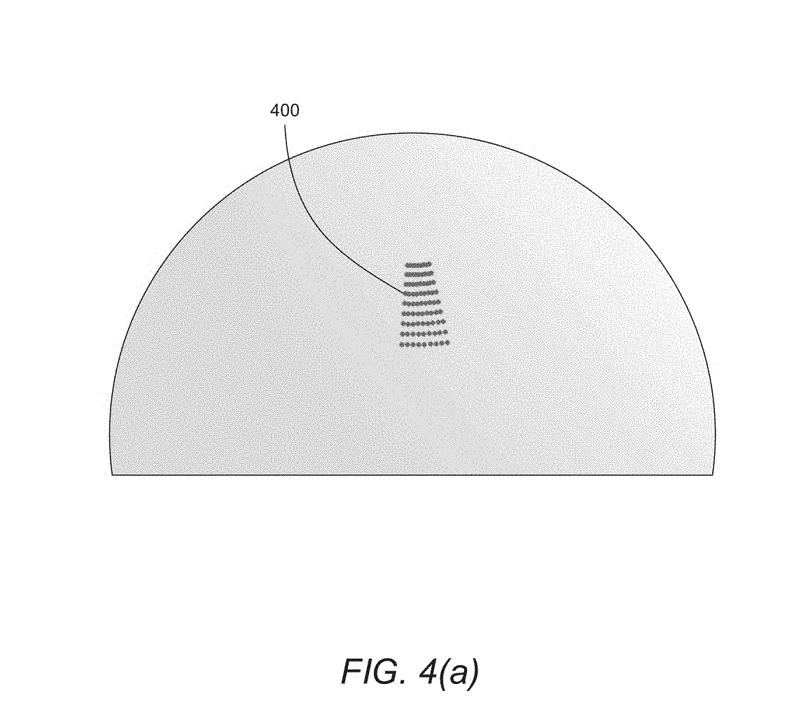

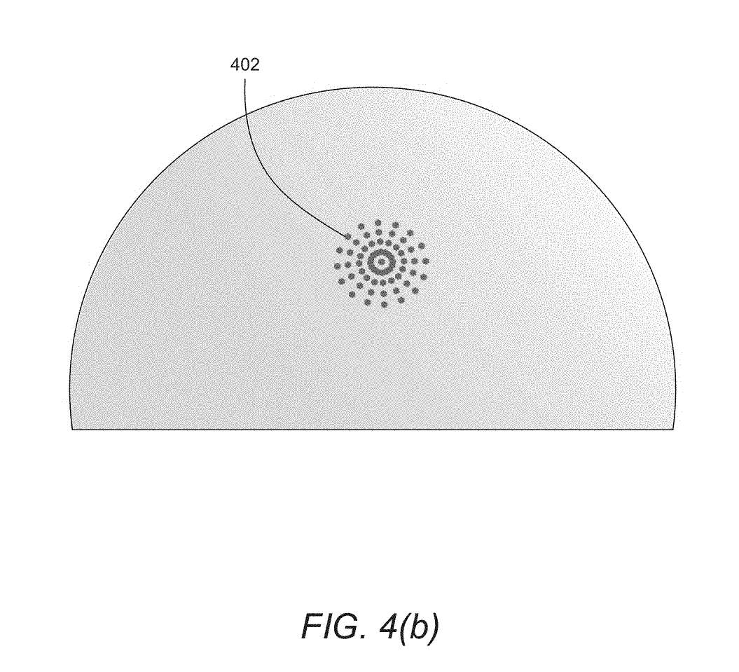

φ′=mΔφ,θ′=π/2−nΔθ (1)

where Δφ and Δθ are predefined step sizes. This search pattern consists of intersections of latitudes and longitudes around the (pretend) “north pole”, effectively forming a radial grid. The pattern is tailored to the sphere's geometry with denser search grid near the center of the block and sparser search grid as one moves away from the center. FIGS. 4(a) and 4(b) illustrate the difference between the preferred embodiment of this invention for search pattern and the search pattern for ERP in HEVC as seen on the sphere, wherein the search grid is arbitrarily denser closer to the actual poles of the sphere. Specifically, FIG. 4(a) depicts the HEVC search pattern 400 and FIG. 4(b) illustrates one embodiment of this invention for a radial search pattern 402, wherein the radial grid used for motion search is comprised of a plurality of grid points that lie on two or more geodesics that intersect at a center of a portion of a current frame being predicted. In another embodiment an orientation of the two or more geodesics that intersect at the center of the portion of the current frame is such that the two or more geodesics are separated by equal angular displacements, and the grid points are equally spaced along the two or more geodesics.

3. Rotation of the Block

The following embodiment focuses on the rotational motion model. Motion is defined as spherical rotation of blocks on the sphere, about a given axis. Specifically, with the new vector v′ defined by the radial search pattern corresponding to a motion vector (m, n), vector v is rotated to v′ about an axis given by unit vector k, via the Rodrigues' rotation formula [11]. This formula gives an efficient method for rotating a vector v in 3D space about an axis defined by unit vector k, by an angle α. Let (x, y, z) and (u, v, w) be the coordinates of the vectors v and k respectively. The coordinates of the rotated vector v′ will be:

x′=u(k·v)(1−cos α)+x cos α+(−wy+vz)sin α,

y′=v(k·v)(1−cos α)+y cos α+(wx−uz)sin α,

z′=w(k·v)(1−cos α)+z cos α+(−vx+uy)sin α (2)

where k·v is the dot product of vectors k and v. Since vector v is to be rotated to v′, the corresponding axis of rotation k and angle of rotation α are calculated to employ Rodrigues' rotation formula. The axis of rotation k is the vector perpendicular to the plane defined by the origin, v and v′ and is obtained by taking the cross product of vectors v and v′, i.e.,

k=(vxv′)/|vxv′| (3)

The angle of rotation is given by,

α=cos⁻¹(v·v′). (4)

Given this axis and angle, all the points in the current block are rotated with same rotation operation. Rotation of block 300 in FIG. 3(b) yields the rotated block 302 in FIG. 3(c). After rotation, the rotated block is mapped to the reference frame using the forward projection. An illustration of rotated block 302 mapped back to the ERP domain is shown in FIG. 3(d). Since the projected location might not be on the sampling grid of the reference frame, interpolation is performed in the reference frame to obtain the pixel value at the projected coordinate.

A preferred embodiment of this invention for motion compensation is summarized in the algorithm below.

1. Map the block of pixels in the current coding unit on to the sphere.

2. Define a radial search pattern around the center of the block v, to obtain the possible set of reference locations v′.

3. Define a rotation operation which rotates v to v′.

4. Rotate all the pixels in the block with the rotation operation defined in Step 3.

5. Map the rotated coordinates on the sphere to the reference frame in the projected geometry.

6. Perform interpolation in the reference frame to get the required prediction.

4. Comparison of Motion Models

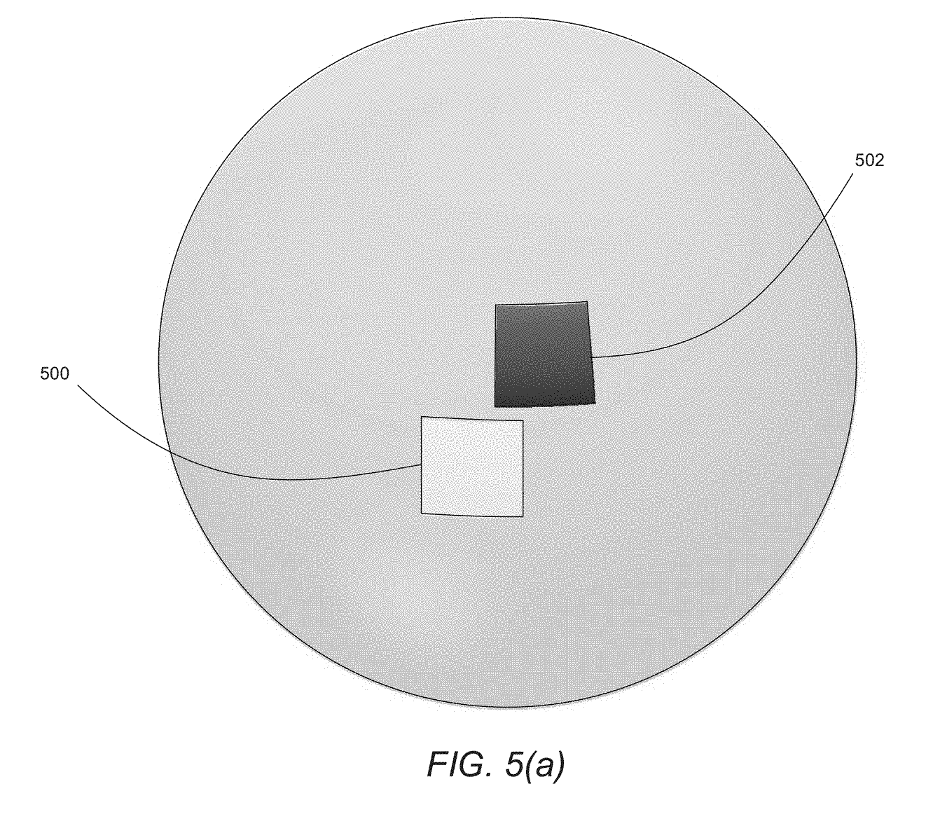

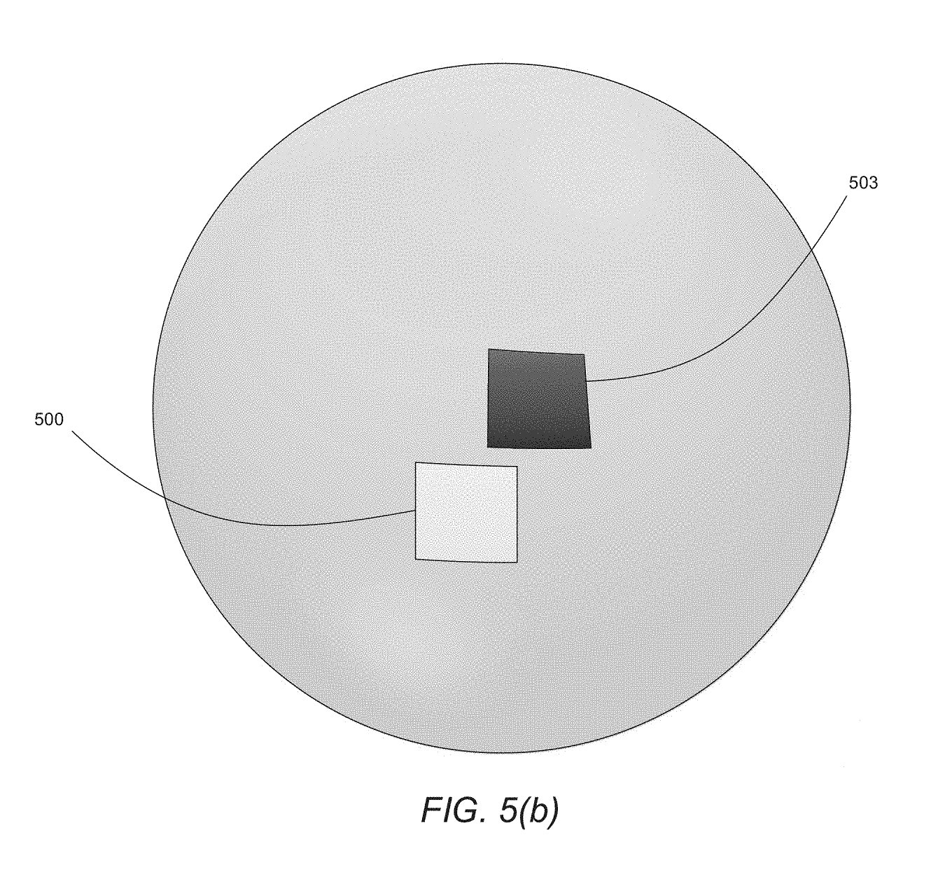

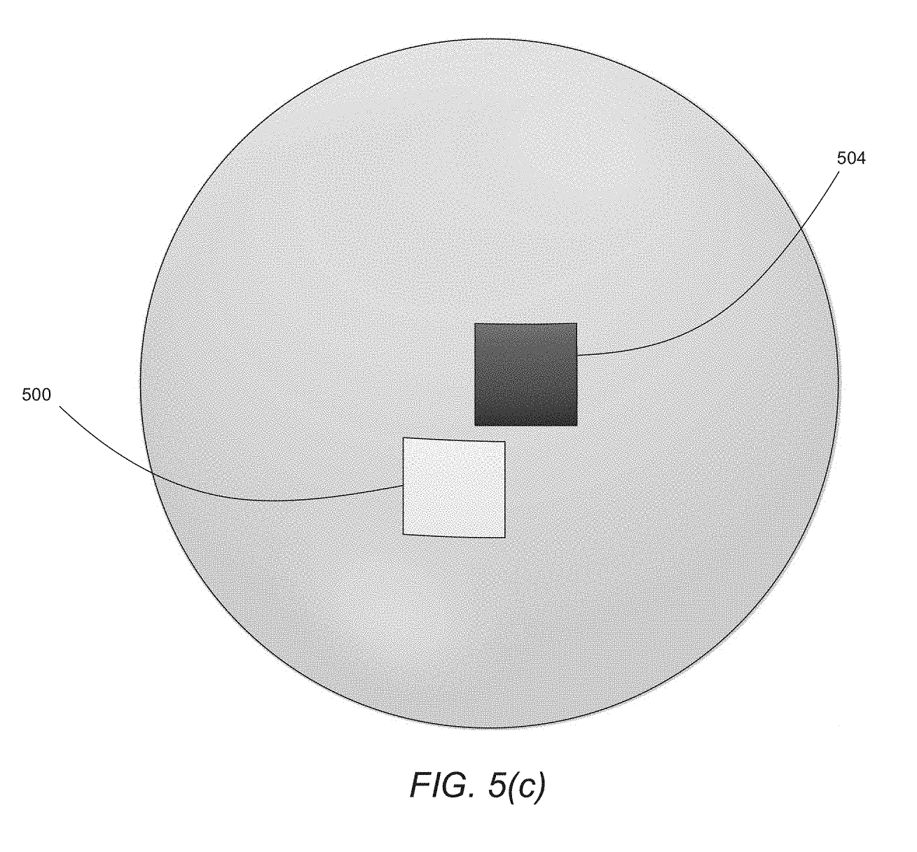

Different motion compensation techniques lead to different shape changes of the object on the sphere. FIGS. 5(a), 5(b) and 5(c) illustrate the differences between the preferred embodiment of this invention, the motion model proposed in [8], and the motion compensation in HEVC. Specifically, FIGS. 5(a), 5(b) and 5(c) illustrate the motion model effect on the block shape (same translation of block center), wherein FIG. 5(a) shows the outcome of the HEVC motion model; FIG. 5(b) shows the outcome of the 3D translation motion model of [8]; and FIG. 5(c) is the outcome of an embodiment of this invention for rotational motion model. The light square 500 is the block of pixels in ERP projected on to the sphere. The pixel locations in the reference frame derived based on different motion models are shown in the dark square labeled 502 for the outcome of the HEVC motion model, 503 for the outcome of the 3D translation motion model of [8] and 504 for the outcome of an embodiment of this invention for rotational motion model. Translation in ERP leads to a shrinkage of the block when moving away from the equator and is clearly seen in FIG. 5(a). As discussed earlier, 3D translation followed by projection on to the sphere results in changes to shape and size of the block, as is clearly seen in FIG. 5(b). The preferred embodiment of this invention preserves the shape and size of the block, which is illustrated in FIG. 5(c). While both the preferred embodiment of this invention and the approach in [8] perform the actual motion compensation in 3D rather than in the projected 2D plane, the preferred embodiment of this invention significantly differentiates in that the motion model is in terms of spherical rotations that ensure preserving object shapes, which is not the case of translation in 3D space. Moreover, the search pattern in [8] inherently depends on the projection geometry and varies across the sphere, in contrast to the location-invariant radial search pattern of the preferred embodiment of this invention.

5. Experimental Results

To obtain experimental results, the preferred embodiment of this invention was implemented in HM-16.14 [12]. The geometry mappings were performed using the projection conversion tool of [13]. Results are provided for the low delay P profile in HEVC. To simplify the experiments, only the previous frame was used as reference frame. Without loss of generality, subpixel motion compensation was disabled. The Lanczos 2 filter was used at the projected coordinate for interpolation in the reference frame. Also sphere padding was employed [14] in the reference frame for improved prediction along the frame edges for all the competing methods. The step size Δφ was chosen to be π/2R (where the search range R was same as what HEVC employs). Δθ in ERP was chosen to be π/H as it corresponds to the change in pitch (elevation) when moved by a single integer pixel in the vertical direction. For CMP, since each face has field of view of π/2, Δθ was chosen to be π/2 W.

30 frames of five 360-video sequences were encoded over four QP values of 22, 27, 32 and 37 in both ERP and CMP. All the sequences in ERP were at 2K resolution and the sequences in CMP had a face-width of 512. The distortion was measured in terms of Weighted-Spherical PSNR as advocated in [15]. Bitrate reduction was calculated as per [16]. The preferred embodiment of this invention provided significant bitrate reduction of about 16% for frames that employ prediction, and overall 11% across all frames, over HEVC in both ERP and CMP domains.

6. Coding and Decoding System

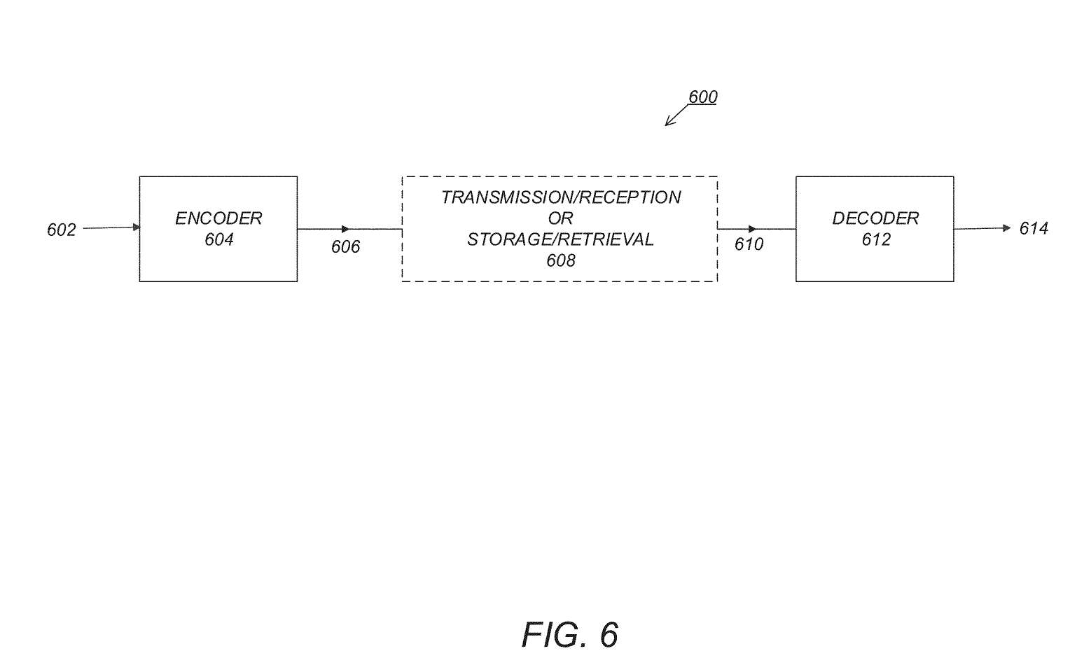

FIG. 6 is a schematic diagram illustrating an exemplary embodiment of a multimedia coding and decoding (codec) system 600 according to one embodiment of the present invention. The codec 600 accepts a signal 602 comprising the multimedia data stream as input, which is then processed by an encoder 604 to generate encoded data 606. The encoded data 606 can be used for transmission/reception or storage/retrieval at 608. Thereafter, the encoded data 610 can be processed by a decoder 612, using the inverse of the functions performed by the encoder 604, to reconstruct the multimedia data stream, which is then output as a signal 614. Note that, depending on the implementation, the codec 600 may comprise an encoder 604, a decoder 612, or both an encoder 604 and a decoder 612.

7. Hardware Environment

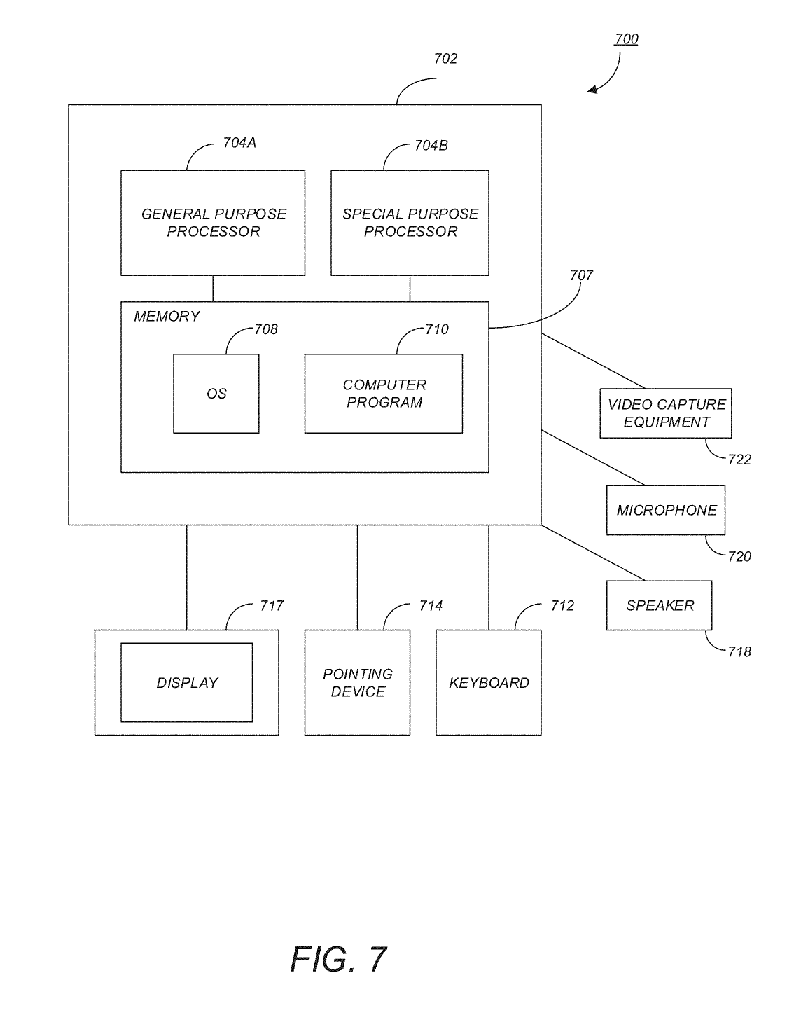

FIG. 7 is an exemplary hardware and software environment 700 that may be used to implement one or more components of the multimedia codec system 600, such as the encoder 604, the transmission/reception or storage/retrieval 608, and/or the decoder 612.

The hardware and software environment includes a computer 702 and may include peripherals. The computer 702 comprises a general purpose hardware processor 704A and/or a special purpose hardware processor 704B (hereinafter alternatively collectively referred to as processor 704) and a memory 707, such as random access memory (RAM). The computer 702 may be coupled to, and/or integrated with, other devices, including input/output (I/O) devices such as a keyboard 712 and a cursor control device 714 (e.g., a mouse, a pointing device, pen and tablet, touch screen, multi-touch device, etc.), a display 717, a speaker 718 (or multiple speakers or a headset), a microphone 720, and/or a video capture equipment 722 (such as a camera). In yet another embodiment, the computer 702 may comprise a multi-touch device, mobile phone, gaming system, internet enabled television, television set top box, multimedia content delivery server, or other internet enabled device executing on various platforms and operating systems.

In one embodiment, the computer 702 operates by the general purpose processor 704A performing instructions defined by the computer program 710 under control of an operating system 708. The computer program 710 and/or the operating system 708 may be stored in the memory 707 and may interface with the user and/or other devices to accept input and commands and, based on such input and commands and the instructions defined by the computer program 710 and operating system 708, to provide output and results.

Alternatively, some or all of the operations performed by the computer 702 according to the computer program 710 instructions may be implemented in a special purpose processor 704B, wherein some or all of the computer program 710 instructions may be implemented via firmware instructions stored in a read only memory (ROM), a programmable read only memory (PROM) or flash memory, or in memory 707. The special purpose processor 704B may also comprise an application specific integrated circuit (ASIC) or other dedicated hardware or circuitry.

The encoder 604, the transmission/reception or storage/retrieval 608, and/or the decoder 612, and any related components, may be performed within/by computer program 710 and/or may be executed by processors 704. Alternatively, or in addition, the encoder 604, the transmission/reception or storage/retrieval 608, and/or the decoder 612, and any related components, may be part of computer 702 or accessed via computer 702.

Output/results may be played back on video display 717 or provided to another device for playback or further processing or action.

Of course, those skilled in the art will recognize that any combination of the above components, or any number of different components, peripherals, and other devices, may be used with the computer 702.

8. Logical Flow

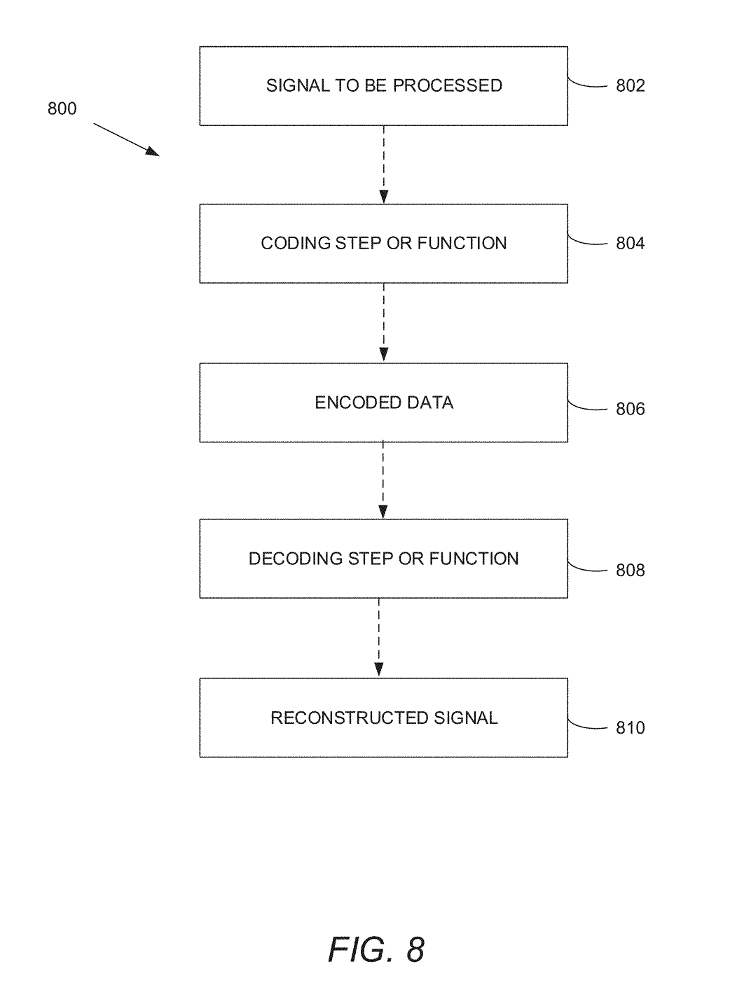

FIG. 8 illustrates the logical flow 800 for processing a signal in accordance with one or more embodiments of the invention. Note that all of these steps or functions may be performed by the multimedia codec system 600, or the multimedia codec system 600 may only perform a subset of the steps or functions. Thus, the multimedia codec system 600 may perform the compressing steps or functions, the decompressing steps or functions, or both the compressing and decompressing steps or functions.

Block 802 represents a signal to be processed (coded and/or decoded). The signal comprises a video data stream, or other multimedia data streams comprised of a plurality of frames.

Block 804 represents a coding step or function, which processes the signal in an encoder 604 to generate encoded data 806.

Block 808 represents a decoding step or function, which processes the encoded data 806 in a decoder 612 to generate a reconstructed multimedia data stream 810.

In one embodiment, the multimedia data stream contains a spherical video signal, and the encoder 604 or the decoder 612 comprises a motion-compensated predictor, which predicts a portion of a current frame from a corresponding portion of one or more reference frames, after motion compensation, and the motion compensation is comprised of rotation on a sphere about an axis. In one embodiment, the encoded data 806 comprises motion information for a portion of the current frame, which identifies the axis of rotation, and a degree of rotation about the axis. In one embodiment, the motion-compensated predictor further performs interpolation in the reference frame to enable the motion compensation at a sub-pixel resolution. In another embodiment, the multimedia data stream contains a spherical video signal, the encoder 600 comprises a motion-compensated predictor, which predicts a portion of a current frame from a corresponding portion of one or more reference frames, and the encoder 600 further performs a motion search on a radial grid comprised of a plurality of grid points that lie on two or more geodesics that intersect at a center of the portion of the current frame. In another embodiment, an orientation of the two or more geodesics that intersect at the center of the portion of the current frame is such that the two or more geodesics are separated by equal angular displacements, and the grid points are equally spaced along the two or more geodesics.

### REFERENCES

The following references are incorporated by reference herein to the description and specification of the present application.
[1] J. P. Snyder, Flattening the earth: two thousand years of map projections, University of Chicago Press, 1997.
[2] T. Wiegand, G. J. Sullivan, G. Bjøntegaard, and A. Luthra, “Overview of the H.264/AVC video coding standard,” IEEE Transactions on Circuits and Systems for Video Technology, vol. 13, no. 7, pp. 560-576, 2003.
[3] G. J. Sullivan, J. Ohm, W. Han, and T. Wiegand, “Overview of the high efficiency video coding (HEVC) standard,” IEEE Transactions on Circuits and Systems for Video Technology, vol. 22, no. 12, pp. 1649-1668, 2012.
[4] M. Narroschke and R. Swoboda, “Extending HEVC by an affine motion model,” in Picture Coding Symposium (PCS), 2013, pp. 321-324.
[5] H. Huang, J. W. Woods, Y. Zhao, and H. Bai, “Control-point representation and differential coding affine-motion compensation,” IEEE Transactions on Circuits and Systems for Video Technology, vol. 23, no. 10, pp. 1651-1660, 2013.
[6] A. Ahmmed, M. M. Hannuksela, and M. Gabbouj, “Fisheye video coding using elastic motion compensated reference frames,” in IEEE International Conference on Image Processing (ICIP), 2016, pp. 2027-2031.
[7] G. Jin, A. Saxena, and M. Budagavi, “Motion estimation and compensation for fisheye warped video,” in IEEE International Conference on Image Processing (ICIP), 2015, pp. 2751-2755.
[8] L. Li, Z. Li, M. Budagavi, and H. Li, “Projection based advanced motion model for cubic mapping for 360-degree video,” arXiv preprint arXiv:1702.06277, 2017.
[9] I. Tosic, I. Bogdanova, P. Frossard, and P. Vandergheynst, “Multiresolution motion estimation for omnidirectional images,” in 13th European Signal Processing Conference. IEEE, 2005, pp. 1-4.
[10] Y. He, B. Vishwanath, X. Xiu, and Y. Ye, “AHG8: Algorithm description of Interdigital's projection format conversion tool (PCT360),” Document JVET-D0021, 2016.
[11] O Rodriguez, “Des lois géoméetriques qui regissent les désplacements d'un systéme solide dans l'espace et de la variation des coordonnées provenant de déplacements considérées indépendant des causes qui peuvent les produire,” Journal de Mathématiques Pures et Appliquées, vol. 5, pp. 380-440, 1840.
[12] “High efficiency video coding test model, HM-16.14,” https://hevc.hhi.fraunhofer.de/svn/svn HEVCSoftware/tags/, 2016.
[13] Y. He, B. Vishwanath, X. Xiu, and Y. Ye, “AHG8: Interdigital's projection format conversion tool,” Document JVET-D0021, 2016.
[14] Y. He, Y. Ye, P. Hanhart, and X. Xiu, “AHG8: Geometry padding for 360 video coding,” Document JVET-D0075, 2016.
[15] Y. Sun, A. Lu, and L. Yu, “AHG8: WS-PSNR for 360 video objective quality evaluation,” Document JVET-D0040, 2016.
[16] G. Bjontegaard, “Calculation of average psnr differences between rd-curves,” Doc. VCEG-M33 ITU-T Q6/16, Austin, Tex., USA, 2-4 Apr. 2001.

### CONCLUSION

In conclusion, embodiments of the present invention provide an efficient and effective solution for motion compensated prediction of spherical video. The solution involves a rotational motion model that preserves the shape and size of the object on the sphere. Embodiments of the invention complement this motion model with a location-invariant radial search pattern that is agnostic of the geometry. The effectiveness of such an approach has been demonstrated for different projection formats with HEVC based coding.

Accordingly, embodiments of the invention enable performance improvement in various multimedia related applications, including for example, multimedia storage and distribution (e.g., YouTube™, Facebook™, Microsoft™). Further embodiments may also be utilized in multimedia applications that involve spherical video.

In view of the above, embodiments of the present invention disclose methods and devices for motion compensated prediction of spherical video.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the invention and the following claims, and the full range of equivalents of the claims.

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto and the full range of equivalents of the claims. The attached claims are presented merely as one aspect of the present invention. The Applicant does not disclaim any claim scope of the present invention through the inclusion of this or any other claim language that is presented or may be presented in the future. Any disclaimers, expressed or implied, made during prosecution of the present application regarding these or other changes are hereby rescinded for at least the reason of recapturing any potential disclaimed claim scope affected by these changes during prosecution of this and any related applications. Applicant reserves the right to file broader claims in one or more continuation or divisional applications in accordance within the full breadth of disclosure, and the full range of doctrine of equivalents of the disclosure, as recited in the original specification.

What is claimed is:

1. An apparatus for processing a multimedia data stream, comprising:
a codec for processing a multimedia data stream comprised of a plurality of frames, wherein the codec comprises an encoder, a decoder, or both an encoder and a decoder;
the encoder processes the multimedia data stream to generate encoded data and the decoder processes the encoded data to reconstruct the multimedia data stream;
the multimedia data stream contains a spherical video signal; and
the encoder or the decoder comprises a motion-compensated predictor, which predicts a portion of a current frame from a corresponding portion of one or more reference frames, after motion compensation, and the motion compensation is comprised of rotation on a sphere about an axis.

2. The apparatus of claim 1, wherein the encoded data comprises motion information for the portion of the current frame, which identifies the axis and a degree of rotation about the axis.

3. The apparatus of claim 1, wherein the motion-compensated predictor further performs interpolation in the reference frames to enable the motion compensation at a sub-pixel resolution.

4. The apparatus of claim 1, wherein the encoder further performs a motion search on a radial grid comprised of a plurality of grid points that lie on two or more geodesics that intersect at a center of the portion of the current frame.

5. A method for processing a multimedia data stream, comprising:
processing a multimedia data stream comprised of a plurality of frames in a codec, wherein the codec comprises an encoder, a decoder, or both an encoder and a decoder;
the encoder processes the multimedia data stream to generate encoded data and the decoder processes the encoded data to reconstruct the multimedia data stream;
the multimedia data stream contains a spherical video signal; and
the processing in the codec comprises motion-compensated prediction, wherein a portion of a current frame is predicted from a corresponding portion of one or more reference frames, after motion compensation, and the motion compensation is comprised of rotation on a sphere about an axis.

6. The method of claim 5, wherein the encoded data comprises motion information for the portion of the current frame, which identifies the axis and a degree of rotation about the axis.

7. The method of claim 5, wherein the motion compensation further comprises interpolation in the reference frames to enable the motion compensation at a sub-pixel resolution.

8. The method of claim 5, wherein the processing in the encoder further comprises a motion search on a radial grid comprised of a plurality of grid points that lie on two or more geodesics that intersect at a center of the portion of the current frame.

9. An apparatus for processing a multimedia data stream, comprising:
a codec for processing a multimedia data stream comprised of a plurality of frames, wherein the codec comprises an encoder, a decoder, or both an encoder and a decoder;
the encoder processes the multimedia data stream to generate encoded data and the decoder processes the encoded data to reconstruct the multimedia data stream;
the multimedia data stream contains a spherical video signal; and
the encoder comprises a motion-compensated predictor, which predicts a portion of a current frame from a corresponding portion of one or more reference frames, and the encoder further performs a motion search on a radial grid comprised of a plurality of grid points that lie on two or more geodesics that intersect at a center of the portion of the current frame.

10. The apparatus of claim 9, wherein an orientation of the two or more geodesics that intersect at the center of the portion of the current frame is such that the two or more geodesics are separated by equal angular displacements, and the grid points are equally spaced along the two or more geodesics.

11. A method for processing a multimedia data stream, comprising:
processing a multimedia data stream comprised of a plurality of frames in a codec, wherein the codec comprises an encoder, a decoder, or both an encoder and a decoder;
the encoder processes the multimedia data stream to generate encoded data and the decoder processes the encoded data to reconstruct the multimedia data stream;
the multimedia data stream contains a spherical video signal;
the processing in the codec comprises motion-compensated prediction, wherein a portion of a current frame is predicted from a corresponding portion of one or more reference frames, and
the processing in the encoder further comprises a motion search on a radial grid comprised of a plurality of grid points that lie on two or more geodesics that intersect at a center of the portion of the current frame.

12. The method of claim 11, wherein an orientation of the two or more geodesics that intersect at the center of the portion of the current frame is such that the two or more geodesics are separated by equal angular displacements, and the grid points are equally spaced along the two or more geodesics.
